(19) United States
(12) Patent Application Publication
(10) Pub. No.: US 2003/0112187 A1
(43) Pub. Date: Jun. 19, 2003

(54) Antenna units

(76) Inventor: Mark Whitehouse, Bristol (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/203,806

(22) PCT Filed: Feb. 13, 2001
(86) PCT No.: PCT/GB01/00584

(30) Foreign Application Priority Data
Feb. 14, 2000 (GB) 0003364.7

(51) Int. Cl. H01Q 1/24

(52) U.S. Cl. 343/702

(57) ABSTRACT

An antenna unit for use in a mobile telecommunications network, which is capable of transmitting and receiving radio signals from the inside of buildings to and from mobile terminals operating in the network. The antenna also prevents the radiation levels within the building from rising above approved safe levels thereby allowing occupiers of the building to continue working in areas adjacent the antenna. Furthermore, the antenna can be located in areas having a large proportion of listed or protected buildings.

The present invention relates in general to antenna units. The invention is particularly, but not exclusively, applicable to an antenna unit for a base station forming a part of a cellular telecommunications network.

Conventionally, in built up areas, antenna units for base stations are fixed on the outside of buildings to provide maximum coverage in any given cell. However, it is a disadvantage of such antennas that they may not be located on the outside walls of listed or protected buildings. Therefore, in cities where many of the buildings are listed, it is difficult to obtain permission to site antennas and as a result, it can be difficult to maintain adequate network coverage in the area.

Furthermore, some do not consider such antennas to be aesthetically pleasing and for this reason, it may be difficult to persuade landlords to site such equipment on their buildings.

U.S. Pat. No. 6,014,110 describes an antenna unit adapted to be mounted onto an interior portion of a building. The antenna includes a horn filled with a dielectric material. The dielectric material may or may not be matched, in terms of indices of refraction, to the material of the interior portion of the building through which the antenna is to receive or transmit signals. Optionally, an intermediate dielectric material may be used to provide a reflectionless match between the material of the horn and the material of the interior portion.

According to a first aspect of the present invention there is provided an antenna unit, comprising a housing locatable on the inside of an external portion of a building and an antenna mounted inside the housing, the unit being arranged such that, when located on the inside of an external portion of a building, the antenna is spaced from the external portion to substantially prevent reflected radiation from the external portion interfering with radio signals transmitted by the antenna.

According to a second aspect of the present invention there is provided a housing for an antenna, the housing being locatable inside a building, the housing comprising means for attaching an antenna and further comprising shielding means for substantially preventing leakage of radio signals from the inside of the housing to the inside of the building, the shielding means being arranged such that radio signals from the inside of the housing may be transmitted and received through an unshielded part of the housing, the housing being arranged such that substantially no dielectric material is disposed between the antenna, when attached, and the unshielded part of the housing.

According to a third aspect of the present invention there is provided an antenna unit comprising a housing locatable on the inside of an external portion of a building and an antenna mounted inside the housing, the unit being arranged such that, when located on the inside of an external portion of a building, substantially no dielectric material is disposed between the antenna and the external portion.

An antenna unit can therefore be located entirely within a building without the exterior of the building being altered. In this manner, antennas can be installed in listed or protected buildings, enabling improved coverage in built up areas. The shielding means prevent the radio signals being transmitted and received from being leaked into the building. The occupants of the building are protected from the radiation transmitted from and received by the antenna to and from the mobile terminals operational within the network.

One advantage of the present invention is that no dielectric material is required between the antenna and the external portion or unshielded part of the housing to counter the effects of reflection and refraction of radio signals. This cost of materials and assembly are reduced in comparison to the antenna unit of U.S. Pat. No. 6,014,110.

Further aspects of the invention are defined in the appended claims, and features thereof will be apparent from the following description.

Embodiments of the invention will now be described, by way of example only, with reference to the accompanying drawings, wherein:

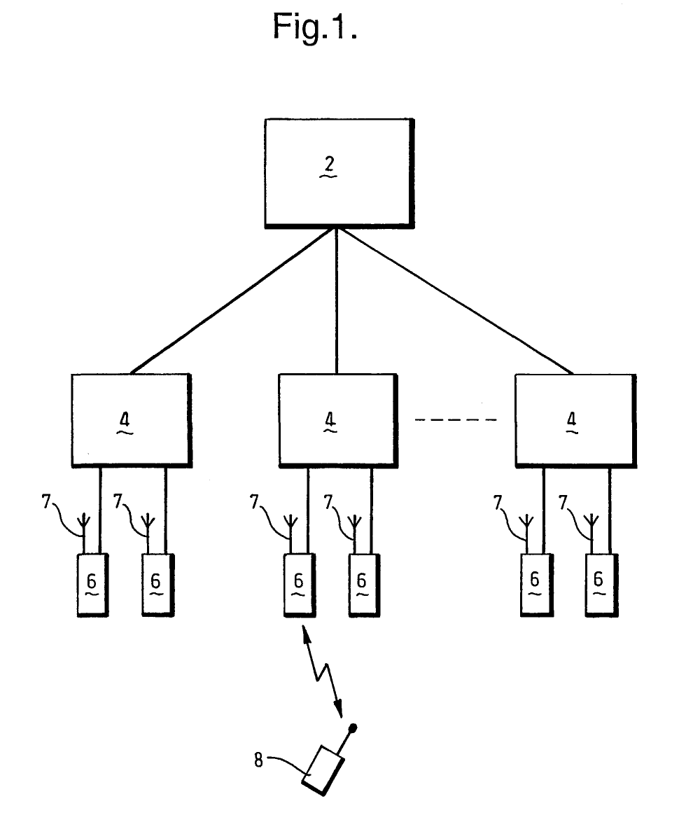

FIG. 1 is a schematic block diagram of a known public land mobile network;

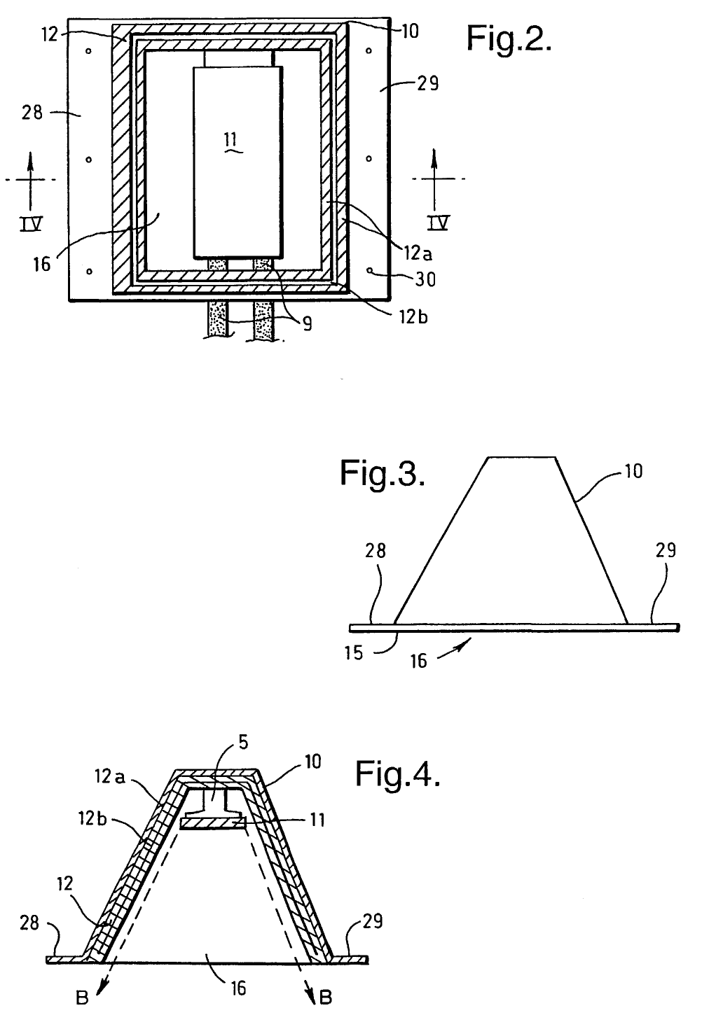

FIG. 2 is a front view of one form of antenna unit in accordance with the invention;

FIG. 3 is a plan view of the antenna unit of FIG. 2; and

FIG. 4 is a cross sectional view of the antenna unit on the line IV-IV of FIG. 2;

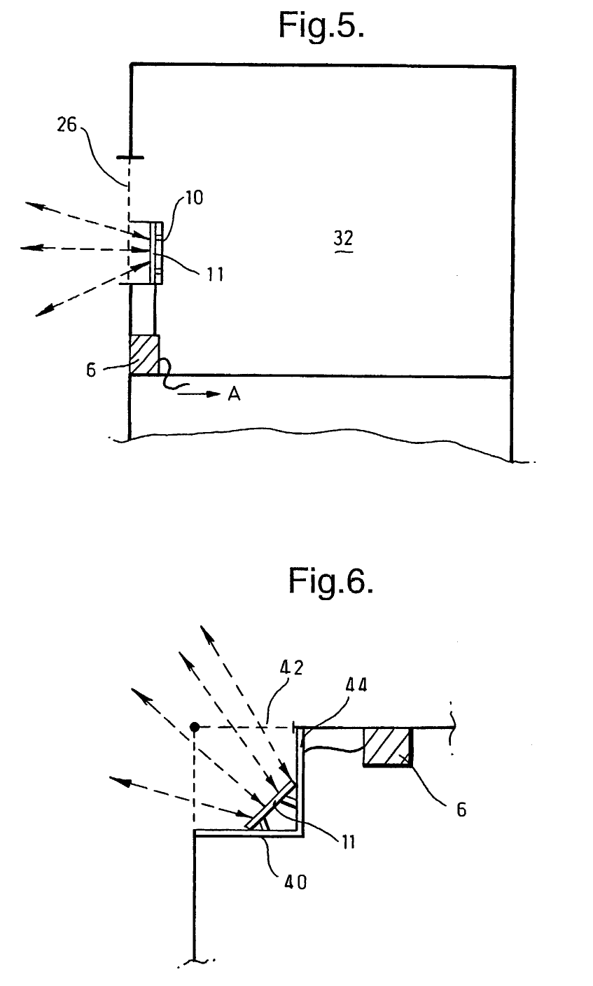

FIG. 5 is a schematic view, vertical section, showing the antenna unit of FIGS. 1 to 4, in position on an upper floor on the inside of a suitable building;

FIG. 6 is a schematic view, horizontal section, of an alternative embodiment of the invention showing a different form of antenna unit installed in an alternative location;

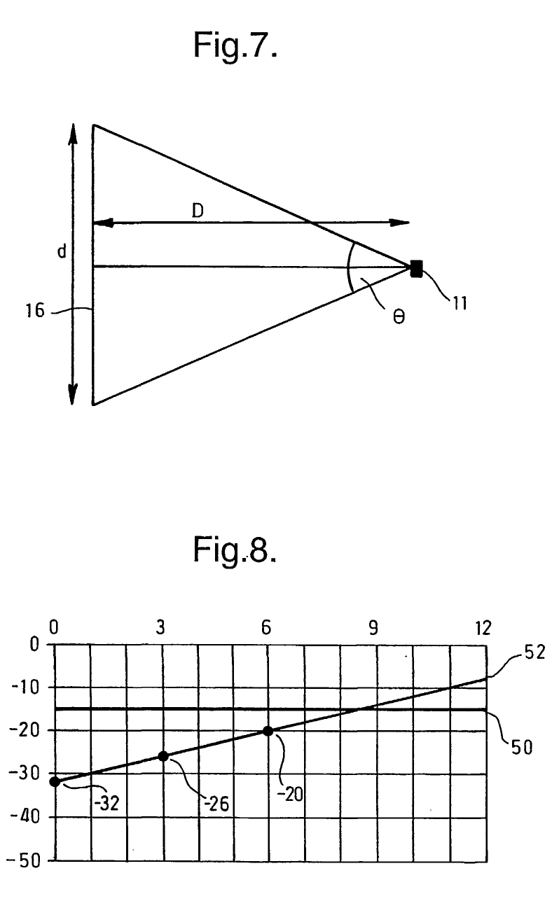

FIG. 7 is a geometric diagram showing the positioning of the antenna within the unit for a desired beamwidth; and

FIG. 8 is a graph showing the results of experiments performed on a prototype antenna unit with and without the presence of a planar glass window.

A known cellular radio network, in this embodiment a GSM network referred to as a public land mobile network (PLMN), is schematically illustrated in FIG. 1. A mobile switching centre (MSC) 2 is connected via communication links to a number of base station controllers (BSCs) 4. The BSCs 4 are dispersed geographically across areas served by the mobile switching centre 2. Each BSC 4 controls one or more base transceiver stations (BTSs) 6 located remote from, and connected by further communication links to, the BSC. Each BTS 6 includes an antenna assembly 7 that transmits radio signals to, and receives radio signals from, mobile stations 8 which are in an area served by that BTS. That area is referred to as a “cell”. A cellular radio network is provided with a large number of such cells, which are ideally contiguous to provide continuous coverage over the whole network territory.

As shown in FIGS. 2, 3 and 4, one form of antenna for use in a cellular radio network in accordance with the invention comprises a housing 10 formed from Glass Fibre Reinforced Plastic (GFRP). The housing 10 shown in FIGS. 2, 3 and 4 is a rigid box formed into a frustotriagular prism with a flat planar open face 15. As will be explained in more detail below, this shape is particularly suited to one form of installation, against a flat planar surface such as a window. However, the shape of the housing 10 may be modified to suit other types of installations. Furthermore, the housing need not be formed from GFRP and any material suitable for forming a housing may be used, such as aluminium.

The housing 10 contains an antenna assembly 11 comprising a directional antenna required for transmitting and receiving radio signals to and from mobile terminals in an arc spanning approximately 80° to 90° directly in front of the antenna. The antenna being a GSM component, the radiation emitted is at a frequency of approximately 900 MHz, 1800 MHz or 1900 MHz. For other cellular systems, the antenna radiates at the relevant appropriate frequency bands. Signal feeders 9 connect the antenna to a base transmitter station 6. The antenna assembly 11 is attached to the housing 10 by an internal mounting bracket 5.

The housing 10 is lined with shielding material 12 that blocks transmission of radio frequencies therethrough. In the example shown in FIG. 2, the shielding material comprises alternating layers of foam 12a impregnated with electrically conductive graphite particles and aluminium foil or paint 12b. However, any suitable radio frequency shielding material may be used. The foam may be any suitable foamed material but is preferably an expanded polymer containing a graphite suspension. This combination of graphite impregnated foam and aluminium foil shields the area outside the housing 10 and prevents the transmission of radiation through the housing 10 into the adjacent area.

The housing 10 has an open portion 16 that is unshielded whilst the remainder of the housing surrounding the antenna is shielded. This portion 16 may be covered with a material that allows the transmission of radio signals therethrough, or simply uncovered. The signal feeders 9 pass through apertures specifically formed in the shielding material for that purpose, the material fitting tightly around the feeders 9 to prevent unwanted leakage.

In use, the unit 1 is positioned across a window 26, as shown in FIG. 5, and attached directly to the window, by adhesion of the flanges 28, 29 thereto, or to the surrounding wall using suitable fixing means such as screws or bolts. The flanges 28 may be provided with a series of holes 30 located on its edge through which screws or bolts could be placed to attach the unit 1 to a wall.

In the case of fixing to the window, the housing need not be fixed to the window 26 permanently, and is preferably demountable to allow access to its interior for maintenance purposes. A fixing mount may be bonded to the window, with the housing attached thereto by releasable fixings such as bolts or screws. The housing may also be fixed to the window 26 by removable glue strips or adhesive tape suitably positioned on the housing 10.

When the antenna unit 1 is attached across the window 26, it is desirable to incorporate additional shielding material in the area between the window 26 and the housing 10 at the point where the housing 10 abuts the window 26. This further shielding may take the form of metallised or conductive tape attached around the edges of the housing to prevent radio signals leaking from inside the housing 10 to the inside of the building 32 through the edge regions.

The shielded housing 10 is designed to block radiation to ensure that radiation levels immediately outside the housing are within regulated levels for human occupancy. In the case of an 1800 MHz antenna, the permitted level defined by the National Radiation Protection Board of Great Britain is 10 mWcm⁻², and the levels immediately outside the housing 10 are within this limit, and preferably lower; at least below 5 mWcm⁻².

The antenna unit 1 is located within a building 32, with the portion 16 of the housing 10 against or across a window 26 or another suitable radio frequency signal outlet such as a vent. It is important that the outlet is relatively transparent to radio frequencies to enable the antenna 11 to transmit and receive signals to and from mobile terminals operating in the network outside the building in which the unit is installed.

The antenna unit 1 can operate normally, and radio signals can be transmitted via the antenna 11 whilst the radiation caused by this transmission, in particular that portion of its radiating power being radiated to the sides and rear of the antenna 11, is prevented from leaking into the building. Furthermore, the glass or other radio-transmissive material in the window 26 may act so as to reflect a portion of the radio signals transmitted by the antenna back into the housing. These reflected signals are also prevented from leaking into the building by the internal shielding 12 of the housing 10.

In the example described above, the divergent shapes of the housing 10 and the shielding 12 substantially conform to the divergent shape of the transmission pattern of the antenna assembly 11. In this way, the housing 10 and the shielding 12 do not significantly obstruct the path of the radio signals B transmitted by the antenna assembly 11. Nevertheless, the antenna unit 1 is compact, thereby ensuring efficient use of the space in the building.

The antenna 11 used in this embodiment is a dual polar panel antenna, such as a Huber and Suhner 321 antenna. It has been found that locating the antenna too close to the window across which the unit 1 is attached degrades the performance of the antenna 11, with the radiation reflected from the window interfering with the transmitted radiation. For a cellular network operating at a radio frequency of 1800 MHz, the antenna is preferably located with its face at least 3 cm away from the inner surface of the window. If the antenna is spaced from the window by too great a distance, the size of the housing becomes undesirably large, and therefore it is preferred that the spacing is less than 10 cm. Optimally the spacing is approximately 6 cm.

In general, for cellular networks, operating at given frequencies, unit 1 is preferably arranged so that the spacing between the antenna and the glass satisfies the following conditions. Referring to FIG. 7, for a unit having an open portion 16 of aperture width d, and requiring a beamwidth θ (for example 80°-90°), geometry provides a maximum spacing D between the antenna 11 and the glass in which:

$$D \leq \frac{d}{2 tan ( \frac{θ}{2} )}$$

A minimum spacing D may be defined as the minimum spacing at which the signal degradation is acceptable. FIG. 8 shows empirical data obtained from tests performed on a prototype unit operating at 1800 MHz and to a planar glass window of standard thickness 6 mm. Loss in received power in decibels (Y axis) was measured at a point 1.285 m from the glass along the normal line passing through the centre point of antenna 11. Plotted against the glass-antenna spacing in centimetres (X axis) are three points showing the loss in received power with the antenna spaced from the glass at 0, 3 and 6 cm respectively. Horizontal line 50 shows the received power with the glass removed. Line 52 extrapolates the three measurements. In fact, line 52 should be asymptotic to horizontal line 50, but a straight line plot provides a useful approximation and provides the result that at approximately 8.4 cm spacing, where lines 50 and 52 cross, the received power is substantially the same as if there was no glass. For the operating frequency of 1800 MHz we have a wavelength of 16.7 cm. This gives a very close approximation to twice the minimum distance obtained from the empirical data. Since the interference effects are dependent on wavelengths, we can devise a more general condition for the minimum spacing between the glass and antenna 11 for an operating wavelength λ as follows:

$$D \geq \frac{λ}{2}$$

Combined with the maximum spacing condition based on geometry 10 we get a general range inequality for determining the glass-antenna spacing D as follows:

$$\frac{λ}{2} \leq D \leq \frac{d}{2 tan ( \frac{θ}{2} )}$$

A corollary of this result is as follows:

$$d \geq λtan ( \frac{θ}{2} )$$

which defines the minimum aperture d of the open portion 16 as a function of wavelength and beamwidth.

It is also to be noted that, for the effects of internal reflections in the glass to be negligible, we require as follows:

λ>>T_{G}

where T_{G} is the thickness of the glass. In normal operating conditions this requirement is satisfied, such as in the tests of the prototype with wavelengths of 16.7 cm and glass of thickness 6 mm.

It will be apparent that the acceptable level of signal degradation caused by placing the antenna close to the glass may vary depending on, for example, the power capacity of antenna 11 and the area of radio coverage required. As mentioned above, other factors, such as the size of the housing, may also be relevant in determining the glass-antenna spacing. Thus, it may be desirable to alter the minimum spacing condition as follows:

$$D \geq \frac{λ}{3}$$

This provides a compromise between the conflicting requirements of maintaining signal strength and reducing the size of the housing. With this compromise, the definition of minimum aperture becomes:

$$d \geq \frac{2 λtan ( \frac{θ}{2} )}{3} \cdot$$

The antenna and housing configuration described is suited to the antenna unit 1 being fixed across a plane window 26. However, it will be appreciated that the housing may be formed in other shapes appropriate to other installations. For example, in another embodiment of the invention as shown in FIG. 5, the housing 40 may be shaped so as to locate across a corner window 42 and attach to two perpendicular windows. The shielding 44 on the inside of the housing 40, which conforms to the internal shape of the housing 40, also prevents substantial leakage of radio transmissions into the building in which the unit is installed.

Other shapes of housing 10 may also be envisaged for installing the antenna unit 1 in an irregular shaped window or across another outlet such as a vent or even a wall which is sufficiently transparent to radio frequencies.

It will be appreciated that further variations are possible without departing from the scope of the invention, which is defined in the accompanying claims.

1. An antenna unit, comprising a housing locatable on the inside of an external portion of a building and an antenna mounted inside the housing,
characterised in that:
the unit is arranged such that, when located on the inside of an external portion of a building,
(i) substantially no dielectric material is disposed between the antenna and the external portion; and
(ii) the antenna is spaced from the external portion to substantially prevent reflected radiation from the external portion interfering with radio signals transmitted by the antenna.

2. An antenna unit according to claim 1, wherein said external portion is a window.

3. An antenna unit according to claim 1 or 2, wherein the spacing between the antenna and the external portion is greater than half the wavelength of radio signals transmitted.

4. An antenna unit according to claim 3, wherein the spacing between the antenna and the external portion is greater than a third of the wavelength of radio signals transmitted.

5. An antenna unit according to any of claims 1 to 3, wherein the transmitted radio signals are required to have a beamwidth of θ and the housing comprises an open portion of width greater than tan
$$( \frac{θ}{2} )$$
multiplied by the wavelength of radiation transmitted.

6. An antenna unit according to any of claims 1, 2 or 4, wherein the transmitted radio signals are required to have a beamwidth of θ and the housing comprises an open portion of width greater than
$$\frac{2}{3} tan ( \frac{θ}{2} )$$
multiplied by the wavelength of radiation transmitted.

7. An antenna unit according to any preceding claim, wherein the spacing between the antenna and the external portion is between 3 cm and 10 cm.

8. An antenna unit according to claim 7, wherein said spacing is approximately 6 cm.
